(19) United States
(12) Patent Application Publication
(10) Pub. No.: US 2024/0421698 A1
(43) Pub. Date: Dec. 19, 2024

(54) DEVICE AND METHOD FOR ADAPTABLE LOW-COST VOLT-VAR CONTROL FOR SMART INVERTER

(71) Applicant: University of Louisiana at Lafayette, Lafayette, LA (US)

(72) Inventors: Farzard Ferdowsi, Lafayette, LA (US); Shayan Ebrahimi, Lafayette, LA (US); S.M. Safayet ULLAH, Lafayette, LA (US)

(73) Assignee: University of Louisiana at Lafayette, Lafayette, LA (US)

(21) Appl. No.: 18/742,239

(22) Filed: Jun. 13, 2024

Related U.S. Application Data
(60) Provisional application No. 63/472,717, filed on Jun. 13, 2023.

(51) Int. Cl. H02M 1/32; H02M 1/00; H02M 1/42; H02M 7/48

(52) U.S. Cl. CPC H02M 1/32; H02M 1/0012; H02M 1/4208; H02M 7/48

(57) ABSTRACT

Volt-VAR control in the smart inverter is used to provide reactive power support to mitigate voltage violation and fluctuation issues through a corrective mechanism (the “Delta-Q” approach) updates the inverter's reactive power set-point to concurrently mitigate voltage violation and fluctuation. Results of experimentation show the effectiveness of the proposed method in comparison with the traditional Volt-VAR control in mitigating voltage violation and fluctuation.

### CROSS REFERENCE TO RELATED APPLICATIONS

This application claims priority to U.S. Provisional Application No. 63/472,717 titled “Adaptable Low-Cost Volt-VAR Control Device for Smart Photovoltaic Inverter”, filed on Jun. 13, 2023.

### STATEMENT REGARDING FEDERALLY SPONSORED RESEARCH OR DEVELOPMENT

Not applicable.

### FIELD OF THE INVENTION

The field of the invention generally relates to solar photovoltaic inverters; specifically, the use of a novel Volt-VAR control device to mitigate voltage violation and fluctuation.

### BACKGROUND OF THE INVENTION

Recent aggressive environmental goals in the United States require a significant growth of about 40% in solar penetration. According to current studies by those having skill in the art, more than 100,000 MW of new solar capacity is expected to become operational by 2025. The increased demand for electrification would require several thousands of gigawatts of solar capacity for achieving decarbonization goals. Similar studies show that the power networks might not be fully ready yet to host a significant growth of solar penetration. Power quality issues including voltage rise and flicker are reported in existing power distribution networks in northwestern Louisiana for solar penetrations between 10% and 20%.

Common power grid issues associated with high penetration of solar may include voltage violations, voltage fluctuations, power losses, and instability. Traditionally, battery storage systems used along with solar facilities to mitigate the referenced power quality issues. This is mainly because batteries can respond quickly to solar-related dynamics. However, the battery's support does not come without a cost. Batteries can be more costly if they are dispatched with a high Depth of Discharged (DoD), which can adversely affect a battery's life.

Traditional devices such as on-load tap changers (OLTC), voltage regulators, and capacitor banks are not quick enough to provide the support to mitigate voltage fluctuations issue. The grid support functions of Smart Inverters (SI) have been game changers within the past few years providing solutions in the form of control schemes that are less costly compared with equipment-based solutions such as storage devices. Like traditional inverters, smart inverters convert the direct current output of solar panels into the alternating current that can be used by consumers in their homes and businesses. Smart inverters go beyond this basic function to provide grid support functions, such as voltage regulation, frequency support, and ride-through capabilities. In different research works, SIs are studied to control power parameters at the solar system's point of interface (POI). The control parameters include but are not limited to voltage, active/reactive power, and frequency.

Among SI's control schemes, the Volt-VAR (wherein “VAR” refers to “Volt-Amp Reactive”) control for voltage regulation at POI is also known. In one known method, multi-objective optimization for different smart inverter functions including Volt-VAR selects the optimal smart inverter curve. In others, an optimal power flow-based approach to select the local Volt-VAR and Volt-Watt settings of SIs for voltage profile enhancement is presented. In another recent study, proposed was a Volt-VAR Optimization (VVO) integrated with Distribution Grid Optimal Power Flow (DOPF) to overcome voltage fluctuation issues. Although the method could lessen the voltage variations, it is computationally extensive.

With many recent advancements in Artificial Intelligence, AI-driven control functions for SIs have remained a top trend in SI control technologies within the past two years. To be more specific, multi-agent Deep Reinforcement Learning (DRL) is proposed in the art as an alternative to the model-based classic control. The proposed control methods ensure the most-rewarded actions (reactive power dispatch) by minimizing voltage violations and active power losses. The effectiveness of DRL-driven Volt/VAR control has been verified on different theoretical feeders including IEEE 4, 33, 34, 69, and 123-bus systems. However, the computational costs associated with DRL-based methods are not well addressed in the literature. That includes an additional capital cost for stronger GPUs as well as operational costs due to more power consumption. Although the application of DRL-aided control in energy systems is on the rise, DRL methods are not benchmarked to be compared with set-point/rule-based strategies that are much simpler to implement. That makes Reinforcement Learning act as Maslow's hammer for setting up SI's control functions including Volt/VAR control.

### BRIEF DESCRIPTION OF THE DRAWINGS

The drawings constitute a part of this specification and include exemplary embodiments of the DEVICE AND METHOD FOR ADAPTABLE LOW-COST VOLT-VAR CONTROL FOR SMART INVERTER, which may be embodied in various forms. It is to be understood that in some instances, various aspects of the invention may be shown exaggerated or enlarged to facilitate an understanding of the invention. Therefore, the drawings may not be to scale.

FIG. 1 provides a line graph of the Q-V curve of the disclosed Volt-VAR control method in smart inverters.

FIG. 2 is an overview of the control parts of the disclosed Delta-Q methodology.

FIG. 3 is an example of a modified IEEE 4-bus system used to test the Delta-Q methodology.

FIG. 4 is a line graph comparison of the voltages of traditional Volt/VAR control method and Delta-Q control approach.

FIG. 5 is a line graph comparison of the active power of traditional Volt/VAR control method and Delta-Q control approach.

FIG. 6 is a line graph comparison of the reactive powers of traditional Volt/VAR control method and Delta-Q control approach.

### SUMMARY OF THE INVENTION

Disclosed herein, a novel method, referred to as the Delta-Q method, may be applied to a Volt-VAR control of SIs to address issues known in the art with current Volt-VAR controls. Unlike machine learning-based control algorithms, the Delta-Q method does not need a lot of communication or training. Thus, Delta-Q performs properly for both large-scale photovoltaic (PV) applications and small-scale ones, like residential roof-top PVs, where fluctuation issues are common. Another advantage of the Delta-Q approach is its adaptability to any sampling time due to its simplicity and fast performance.

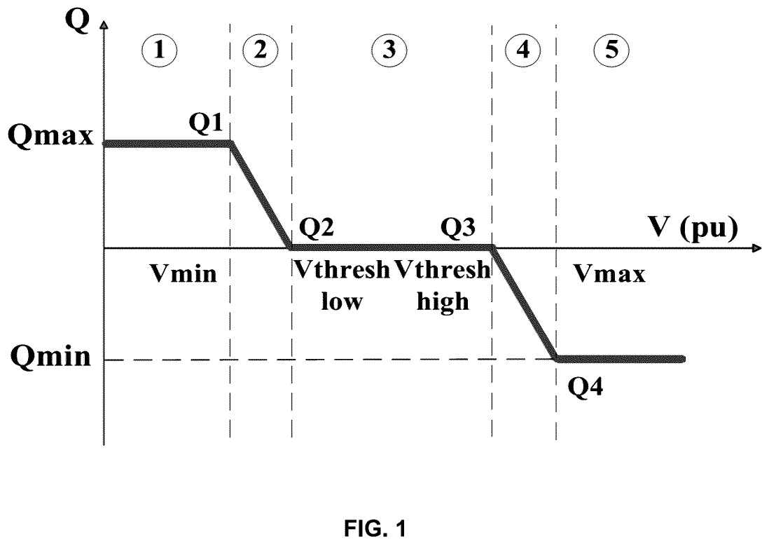

Volt-VAR control methods inject/absorb a certain amount of reactive power, based on the reference voltage to keep the voltage of POI within a permissible range, e.g. 0.95 pu to 1.05 pu (ANSI standard) in each sample time Ts. Q-V curves are useful tools for evaluating the sensitivity and variation of bus voltages with respect to reactive power injections or absorptions. The Q-V curve of an embodiment of the disclosed Volt-VAR control method is illustrated in FIG. 1. In the preferred embodiment, if the voltage remains in the dead band region (zone 3 in FIG. 1), there will be no reactive power support from the smart inverter.

Traditional Volt-VAR control methods keep injecting/absorbing a specific amount of reactive power for the whole one sample time Ts. For instance, when the reference voltage falls in zone 4, the Volt-VAR control unit of SI sends a command of absorbing a constant value of Q_{ref} for the whole duration of one sample time Ts. The problem, however, is prompted when the solar irradiance is abruptly changing. This can have a negative impact on the output voltage profile of PV's SI and can lead to voltage fluctuations since in statistic Volt-VAR control methods the value of Q_{ref} remains constant for the whole sample time Ts.

The mentioned problem can reveal its negative impact more on small-scale roof-top PVs. Fluctuations with large magnitude and high frequency can affect the power quality in terms of visible flicker.

### DETAILED DESCRIPTION OF THE INVENTION

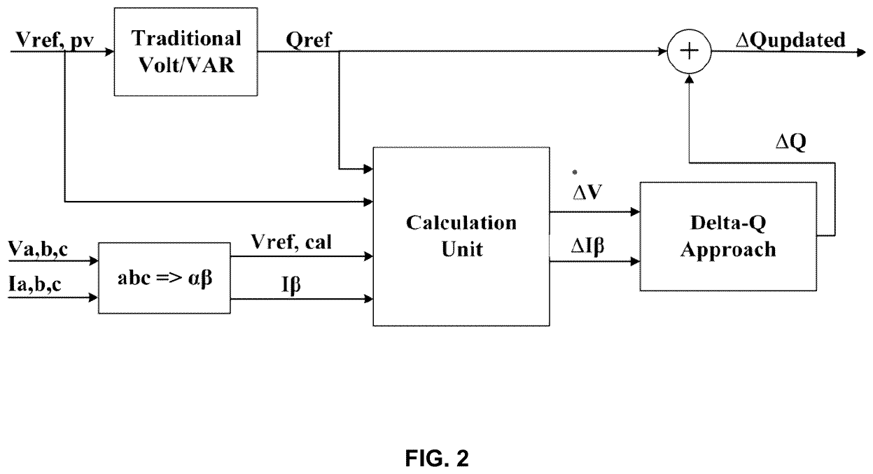

The disclosed Delta-Q method concurrently mitigates voltage fluctuations and violation (voltage rise). The general approach of the proposed Delta-Q control strategy may be to keep updating the value of reference reactive power, Q_{ref}, calculated by a SI's Volt-VAR control for each sample time T. In one embodiment, the sample time T may be 1 minute. An overview of the control parts of the Delta-Q method may be illustrated in FIG. 2. As shown in FIG. 2, the device implementing the Delta-Q method may comprise a Volt-VAR control unit 6, a calculation unit 7, an adder 8, a converter 5, and a Delta-Q unit 9.

As shown in the embodiment of the device as depicted in FIG. 2, the value of Q_{ref} may be added to the ΔQ term by the adder 8, allowing ΔQ_{updated} to mitigate the voltage fluctuations. The value of ΔQ may be dependent on two or more factors. One factor may be to what extent solar irradiance is intermittently led to abrupt variations in the output voltage of PV. Another factor may be the value of the threshold set for the proposed Delta-Q approach to start taking action. If the difference between the instantaneous voltage and the reference voltage is greater than the threshold, the Q_{ref} may be updated by ΔQ.

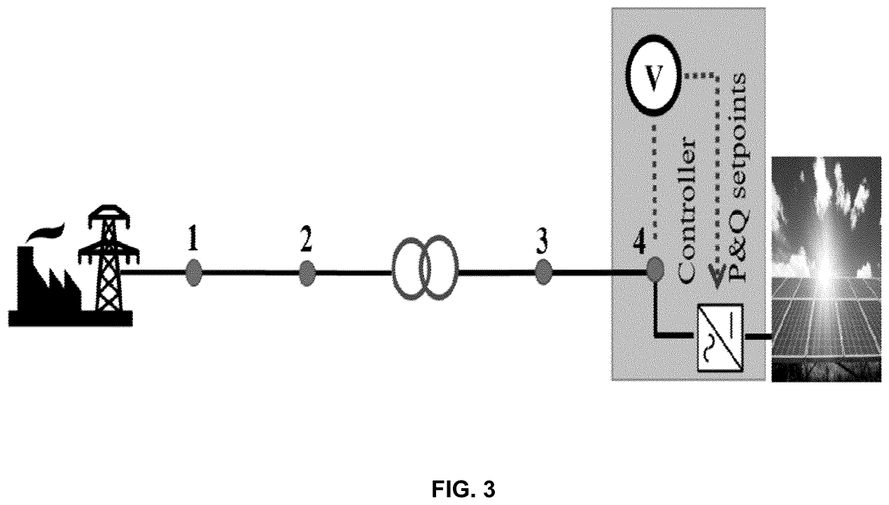

An embodiment of the mathematical equations supporting the Delta-Q approach in the per unit (pu) system are presented herein. As shown in FIG. 2, phase voltages and currents at node 4 of FIG. 3 may be constantly measured and converted to the two components system via the following transformation formula.

$$[ \begin{matrix}{V}_{α} \\ {V}_{β}\end{matrix} ] = \frac{2}{3} [ \begin{matrix}cos 0 & cos \frac{2 π}{3} & cos \frac{4 π}{3} \\ sin 0 & sin \frac{2 π}{3} & sin \frac{4 π}{3}\end{matrix} ] [ \begin{matrix}{V}_{a} \\ {V}_{b} \\ {V}_{c}\end{matrix} ] \qquad ( 1 )$$

$$[ \begin{matrix}{I}_{α} \\ {I}_{β}\end{matrix} ] = \frac{2}{3} [ \begin{matrix}cos 0 & cos \frac{2 π}{3} & cos \frac{4 π}{3} \\ sin 0 & sin \frac{2 π}{3} & sin \frac{4 π}{3}\end{matrix} ] [ \begin{matrix}{I}_{a} \\ {I}_{b} \\ {I}_{c}\end{matrix} ] \qquad ( 2 )$$

By having V_{α} and V_{β} from FIG. 1, the instantaneous voltage reference (V_{ref,cal}) during one sample time Ts (1-minute) may be calculated. This voltage may be continuously compared with the reference voltage calculated by a SI's Volt-VAR control unit 6 of PV, V_{ref,pv}, to produce the error of voltage as below through Equation 3:

$$Δ V = {V}_{ref , pv} - {V}_{ref , cal} \qquad ( 3 )$$

where ΔV may comprise the calculated error between two reference voltages and where ΔV is constantly compared with a specific threshold determined from the sensitivity required for applications.

Once ΔV is greater than the threshold, the disclosed control method may take action to minimize the difference between V_{ref,cal} and V_{ref,pv} by updating the amount of reference reactive power through Equation 4:

$${Q}_{ref , updated} = {Q}_{ref , old} + Δ Q \qquad ( 4 )$$

where Q_{ref,updated} and Q_{ref,old} may comprise the updated and traditional Volt-VAR reference reactive power, respectively.

Moreover, ΔQ may be the additional amount of reactive power required for mitigating voltage violations, which can be calculated using Equation 5:

$$Δ Q = \vert Δ V \vert \vert Δ {I}_{β} \vert \qquad ( 5 )$$

where ΔI_{β} is the difference between the reference I_{β} of the SI's Volt-VAR control unit of PV and I_{β} calculated in Equation 2 above.

In an embodiment, adding or subtracting ΔQ to ΔQ_{ref,old} may be highly dependent on both the sign of ΔV and SI's operation zone. Thus, the absolute amounts of ΔV and ΔI_{β} may be applied to calculate the value of ΔQ in Equation 5 above. The sign of ΔV and SI's operation zone may assist in updating Q_{ref,updated} in Equation 4.

The steps of an embodiment of the disclosed Delta-Q approach are presented, aiming to mitigate voltage violations/fluctuations. First, a system may check the value of ΔV to determine whether the difference in value between V_{ref,cal} and V_{ref,pv} is bigger than the set threshold. The system may also check the SI operation zone. In an embodiment, the operation zone is detected through comparison to the Q-V curve of FIG. 1. The system may next check the sign of ΔV. If the ΔV is positive, then the ΔQ in Equation 5 will have a positive sign. If the ΔV is negative, then the ΔQ in Equation 5 will have a negative sign. Otherwise, the ΔQ in Equation 5 may be equal to zero. The system will then update the reference Q, and the result of the preceding step may update Equation 4.

Per the IEEE 1547-2018 standard, the reactive power injecting/absorbing capacity is set to 0.44 pu. It means that the maximum reactive power support injection in zone 1 of the FIG. 1 is limited to 0.44 pu. Thus, ΔQ in Equation 5 should be equal to zero due to maximum injection by the traditional Volt/VAR control unit. The same limitation is applied to absorption in zone 5, thereby ΔQ is equal to zero in this case.

In the preferred embodiment, the Delta-Q control unit(s) 9 includes one or more Volt/VAR control units 6 (as seen in FIG. 2). In an experimental embodiment, the Volt-VAR control units 6 may be mounted in dSAPCE MicroLabBox to run as a real-time application. The measured signals may be transferred from Typhoon HIL 402 through Typhoon-dSAPCE interface board connection to dSPACE to take required actions and send the final result of Q_{ref,updated} back to the Typhoon. Since the whole process of updating Q_{ref} takes less than 200 μs, the proposed Delta-Q is fast enough to update Q_{ref} a couple of times during one sample time Ts.

To evaluate the performance of the proposed dynamic Volt-Var control method, a modified IEEE 4 bus system may be applied, as shown in FIG. 3. To analyze the major impact of higher PV penetrations in this IEEE 4 bus system, a single solar plant may be connected to bus 4 which is the most remote place in this radial IEEE system. The nominal active power of the solar PV plant may be 180 kW, and the peak load apparent power may be 181.96 kVA. So, a high PV penetration level is utilized in this research which is around 98%. Higher solar irradiance is required to produce maximum solar power from solar PV plant. For this testing purpose, 1-minute interval of higher solar radiation data may be utilized. Real load data set is utilized on the load bus of this test system. The smart inverter is operating with the reactive power priority mode. Therefore, it will always prioritize reactive power support to the power grid by curtailing the active power generation of the solar PV plant.

For the real-time test, Typhoon HIL 402 and dSPACE MicroLabBox can be used. After measuring the required inputs for control units including V_{ref,cal}, I_{β}, and V_{ref,pv}, they are transferred through the interface board from Typhoon HIL 402 to dSPACE MicroLabBox. Then, the control unit starts processing the data to calculate the amount of ΔQ required for mitigating voltage fluctuations during each sample time Ts. Eventually, the updated value of Q_{ref,updated} can be sent back to Typhoon HIL 402 due to applying on the SI.

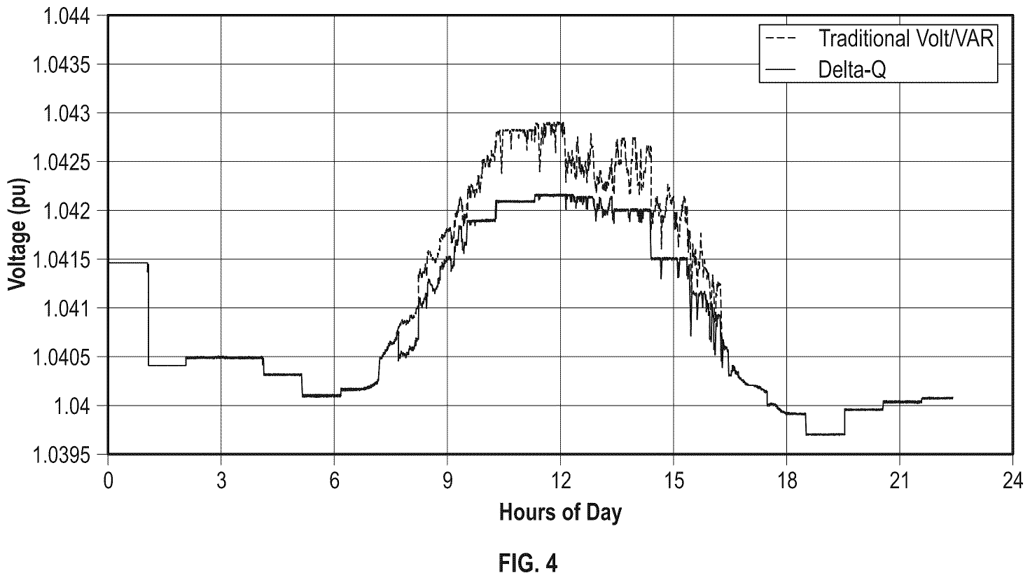

The operation and behavior of the Delta-Q control method is then simulated and discussed in this section. As it can be seen in FIG. 4, the traditional Volt-VAR control method keeps the voltage below 1.05 pu. Its voltage curve, however, contains abrupt voltage fluctuations which can bring power quality issues in the distribution network for large-scale PV applications. In this voltage variation situation, the Delta-Q approach takes effective actions to reduce the fluctuations to further smooth the voltage profile. Not only the Delta-Q method brings the peak voltage down, but also it can reduce the abrupt voltage variations to a great extent which can be seen in FIG. 4.

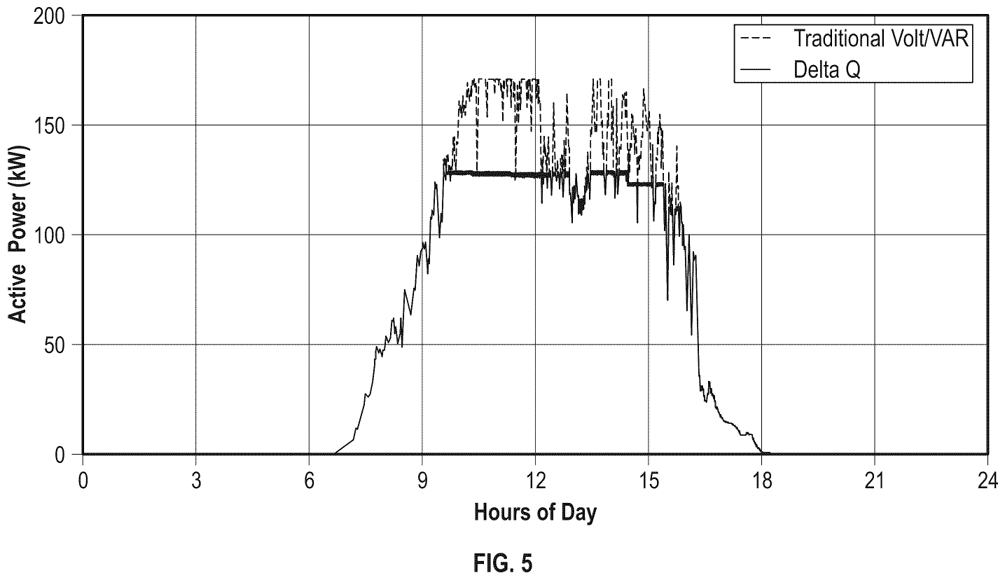

In FIG. 5, the amounts of delivering active power generation by PV for both the traditional Volt-VAR control method and the Delta-Q approach are illustrated. Although the traditional Volt-VAR control method can provide more active power in comparison with the Delta-Q approach, it is not able to mitigate voltage fluctuations issues. This means that to lessen the number of fluctuations in the voltage curve during abrupt solar irradiance variation, more active power should be curtailed to temporarily absorb more reactive power and have an acceptable voltage profile.

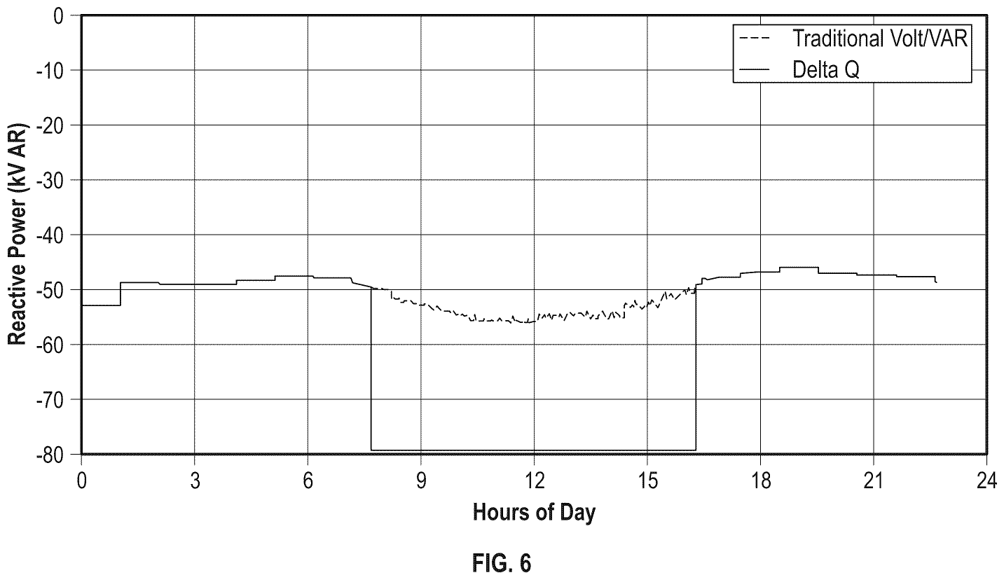

The amounts of absorbing reactive power by SI for both the traditional Volt-VAR control method and the Delta-Q approach are shown in FIG. 6. Due to the large number of voltage fluctuations, Delta-Q can update Q_{ref} in a way that absorbs more to the minimum reactive power limit of 44% in comparison to traditional Volt-VAR control. Although this means curtailing more active power, it makes a substantial contribution to smoothing the voltage profile and addressing power quality issues to a great extent.

The Delta-Q method can update the value of reactive power reference to mitigate the abrupt voltage fluctuations caused by intermittent nature of solar irradiance. Therefore, based on the amount of voltage variations and the value of threshold set associated with level of sensitivity, Delta-Q approach can play an effective role in changing the value of Q_{ref} accordingly. Even though Delta-Q in a situation with lots of voltage variations curtails more active power in comparison with traditional Volt/VAR control methods, it can considerably reduce the negative effects of voltage fluctuations.

The Delta-Q approach substantially mitigates voltage fluctuations in the voltage of SI to a great extent, but also it can reduce the pick of voltage in comparison to traditional Volt-VAR control method. Another significance of Delta-Q is its simplicity concept which considerably reduces cost in comparison to DRLs. Moreover, it is capable of performing and reacting fast with no needs of training like DRLs. Furthermore, due to its time sample adaptable capability, there is no need to make extra sample time which brings redundant complexity to control process like other dynamic Volt-VAR control methods.

The foregoing description sets forth exemplary methods, parameters, and the like. It should be recognized, however, that such description is not intended as a limitation on the scope of the present disclosure but is instead provided as a description of exemplary embodiments.

In the foregoing description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure. Such changes and modifications are to be understood as being included within the scope of the disclosure and examples as defined by the claims.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

The present invention also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMS, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention, as described herein.

The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

We claim:

1. A device for mitigating voltage fluctuations in a smart inverter system comprising:
a reference voltage;
a Volt-VAR control unit;
a three-phase voltage input;
a current input;
a converter;
a calculation unit;
an adder;
a Delta-Q unit; and
an updated Delta-Q output, wherein the updated Delta-Q output comprises an updated reference reactive power.

2. The device of claim 1, wherein the converter comprises functionality to convert the three-phase voltage input and current input each to respective two-phase orthogonal components.

3. The device of claim 1, wherein the converter comprises functionality to perform one or more Clarke transformations to convert the three-phase voltage input and current input each to respective two-phase orthogonal components.

4. The device of claim 1, wherein the converter comprises functionality to convert the three-phase voltage input and current input each to respective two-phase orthogonal components, and wherein each two-phase orthogonal components comprise one or more inputs to the calculation unit.

5. The device of claim 1, wherein calculation unit comprises the following inputs:
one or more voltage inputs;
one or more current inputs;
the reference volume; and
a reference reactive power.

6. The device of claim 1, wherein the reference voltage comprises an input to the Volt-VAR control unit, and wherein a reference reactive power comprises an output of the Volt-VAR control unit.

7. The device of claim 1, wherein the calculation unit comprises functionality to calculate an error between an at least two reference voltages.

8. The device of claim 1, wherein the adder comprises functionality to produce the updated reference reactive power.

9. A method for performing Volt-VAR control in a smart inverter system comprising, comprising:
a. providing smart inverter system comprising:
a reference voltage;
a Volt-VAR control unit;
a three-phase voltage input;
a current input;
a converter;
a calculation unit;
an adder;
a Delta-Q unit; and
an updated Delta-Q output.
b. setting a value for the reference voltage;
c. inputting values for the three-phase voltage input and current input into the converter;
d. converting the three-phase voltage input and current input each to respective two-phase orthogonal components, comprising a voltage component and a current component;
e. inputting the reference voltage into the Volt-VAR control unit to generate a reference reactive power;
f. inputting the reference reactive power, reference voltage, and two-phase orthogonal components into the calculation unit;
g. comparing the value of the reference voltage to the voltage component value to determine a voltage error;
h. comparing the voltage error to a threshold value set by a user;
i. when the voltage error exceeds the threshold value, updating a value of the reference reactive power by applying a Delta-Q mitigation process; and
j. adding an additional reactive power value to the reference reactive power.

10. The method of claim 9, wherein the Delta-Q mitigation process comprises:
a. once the voltage error exceeds the threshold value, checking which operation zone the smart inverter is presently operating in;
b. determining whether the voltage error value is positive or negative, wherein:
i. if the voltage error is positive, the additional reactive power value is positive; and
ii. if the voltage error is negative, the additional reactive power value is negative.
